(19) United States
(12) Patent Application Publication
(10) Pub. No.: US 2008/0204564 A1
(43) Pub. Date: Aug. 28, 2008

(54) IMAGE PICKUP APPARATUS AND LENS BARREL

(75) Inventor: Naoto Yumiki, Osaka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/033,087

(22) Filed: Feb. 19, 2008

(30) Foreign Application Priority Data
Feb. 22, 2007 (JP) 2007-042065

(51) Int. Cl. H04N 5/228

(52) U.S. Cl. 348/208.99; 348/222.1; 396/55; 348/E05.031

(57) ABSTRACT

An imaging apparatus capable of preventing photographing sensitivity from being increased more than necessary, reducing image quality degradation caused by camera shake or object shake and easily photographing images in good image quality. Digital camera 1 includes image shake correcting selection 16 that corrects shake of an optical image of a photographing object formed by an imaging optical system L, digital signal amplification section 110 that amplifies an image signal with a gain set by digital signal gain setting section 111, and face detection section 120 that detects a face of a photographing object, and microcomputer 3 calculates an object speed based on the detected motion of the face of the photographing object, decides whether or not the object speed is equal to or higher than a threshold A, and operates, when the object speed is lower than the threshold A, image shake correction by controlling image shake correcting section 16 or increases, when the object speed is equal to or higher than the threshold A, the gain of digital signal gain setting section 111, increases ISO sensitivity to increase the shutter speed and shorten the exposure time.

### CROSS REFERENCE TO RELATED APPLICATIONS

The disclosure of Japanese Patent Application No. 2007-042065, filed on Feb. 22, 2007, including the specification, drawings and abstract, is incorporated herein by reference in its entirety.

### BACKGROUND OF THE INVENTION

1. Field of the Invention

The present invention relates to an imaging apparatus and lens barrel. More particularly, the present invention relates to an imaging apparatus and lens barrel having a camera shake correcting function and a photographing sensitivity changing function.

2. Description of Related Art

Imaging apparatuses such as digital still cameras and digital video cameras that convert an optical image of a photographing object to an electrical image signal and outputs the image signal (hereinafter simply referred to as “digital cameras”), have become popular. With reductions in size and weight and escalation in the magnification of optical zooming in recent years in particular, digital cameras have become convenient for photographers.

However, accompanying reductions in size and weight and escalation in the magnification of optical zooming of digital cameras, a blur may occur in photographed images and may cause image quality degradation.

Patent Document 1 (Japanese Patent Application Laid-Open No. 2000-13671) discloses a digital camera with a blur correcting optical system that reduces the influence of image shake upon the image when a photograph is taken. The digital camera disclosed in Patent Document 1 moves the correction lens up, down, left and right in directions perpendicular to the optical axis, depending on image shake of when a photograph is taken, and corrects image distortion. By this means, it is possible to take a photograph with reduced image shake using a smaller-sized and lighter-weighted digital camera. Furthermore, the digital camera disclosed in Patent Document 1 does not have to use a flash lamp to emit light upon taking a photograph to prevent image shake, so that it is possible to take a photograph under conditions producing similar atmosphere to natural colors.

On the other hand, among causes for degrading image quality of photographed images is object shake caused by the motion of the photographing object, in addition to camera shake caused by vibration such as caused by a shaking hand, added to the camera. Object shake can be prevented by making exposure time shorter and taking a photograph at a high shutter speed. Shutter speed can be made faster by, for example, increasing photographing sensitivity or by flashing flash lamp. As for optical image shake of the photographing object in the imaging plane, shake caused by vibration applied to the camera will be referred to as “camera shake” and shake caused by the motion of the photographing object will be referred to as “object shake.” Camera shake and object shake will be collectively referred to as “image shake” with respect to the imaging plane.

Patent Document 2 (Japanese Patent Application Laid-Open No. 2006-157428; US 2006/0115297 A1) discloses an apparatus with a motion prediction section for predicting the motion of the photographing object and changing photographing conditions such as shutter speed when the photographing object is likely to move, and a method applicable with the apparatus.

Patent Document 3 (Japanese Patent Application Laid-Open No. 2003-107335; U.S. Pat. No. 7,298,412 B2 etc.) discloses a technique of detecting the face, eyes, nose and mouth of a person in image data, using part of the detected face of the person as the automatic focus area (herein after “AF area”) and performing automatic focus control.

Generally, when photographing sensitivity is increased, the output signal from the imaging sensor is amplified, and, consequently, noise generated from the imaging sensor is also amplified. Therefore, an image taken in high sensitivity contains a large amount of noise. Increasing photographing sensitivity more than necessary may thus result in image quality degradation. It is therefore desirable to increase photographing sensitivity when camera shake still occurs due to insufficient ambient brightness after correction by the correcting optical system or when a fast-moving photographing object is photographed.

However, with such a conventional imaging apparatus, it is difficult for photographers to identify what level of moving speed of the photographing object causes object shake. Therefore, cases often occur where even though it is possible to take a photograph without object shake, the photographer observing the motion of the photographing object misjudges that object shake will occur. As a result, there is a problem that the photographers change photographing sensitivity to high sensitivity and take a photograph containing a large amount of noise. Furthermore, there is a problem that photographers need to change photographing sensitivity immediately before taking a photograph and might miss the chance to take a photograph.

That is, a general photographer cannot identify what level of moving speed of the photographing object will or will not cause object shake. In other words, using the camera shake correcting function may result in taking a photograph with object shake when the photographing object is moving fast, and increasing ISO sensitivity may result in taking a photograph with a large amount of noise when the photographing object is moving slowly. Therefore, taking photographs in good quality is not possible.

Furthermore, although the digital camera having a blur correcting optical system disclosed in Patent Document 1 can reduce image quality degradation due to camera shake, there is no proposal of easing image quality degradation caused by object shake.

Furthermore, since the digital camera disclosed in Patent Document 2 is only directed to predicting the motion of the photographing object and is not directed to deciding what level of moving speed of the photographing object will or will not cause object shake, it is not always possible to take a photograph at an optimal shutter speed matching the speed of the photographing object.

### SUMMARY OF THE INVENTION

It is therefore an object of the present invention to provide an imaging apparatus and lens barrel that reduce image quality degradation due to camera shake and object shake by preventing photographing sensitivity from being increased more than necessary and enabling images in good quality to be photographed.

According to an aspect of the present invention, an imaging apparatus employs a configuration having: an imaging optical system that forms an optical image of a photographing object; an imaging sensor that receives the formed optical image, converts the optical image to an electrical image signal and outputs the image signal; a face detection section that detects a face of the photographing object based on the image signal; an object speed decision section that measures motion of the optical image of the face of the photographing object in a predetermined time before a photograph is taken, and calculates an object speed of the photographing object; and a control section that takes, when the calculated object speed is equal to or higher than a threshold, a photograph at a higher amplification factor of the image signal and in a shorter exposure time.

According to another aspect of the present invention, an imaging apparatus body is used in combination with a lens barrel mounted with a camera shake correcting section that corrects shake of an optical image caused by motion of the imaging apparatus body, the imaging apparatus body having: an imaging sensor that receives a formed optical image, converts the optical image to an electrical image signal and outputs the image signal; a face detection section that detects a face of a photographing object based on the image signal; an object speed decision section that measures motion of the optical image of the face of the photographing object in a predetermined time before a photograph is taken, and calculates an object speed of the photographing object; and a control section that takes, when the calculated object speed is equal to or higher than a threshold, a photograph at a higher amplification factor of the image signal and in a shorter exposure time.

According to yet another aspect of the present invention, a lens barrel is used in combination with an imaging apparatus body, the imaging apparatus body having: an imaging optical system that forms an optical image of a photographing object; an imaging sensor that receives the formed optical image, converts the optical image to an electrical image signal and outputs the image signal; a face detection section that detects a face of the photographing object based on the image signal; an object speed decision section that measures motion of the optical image of the face of the photographing object in a predetermined time before a photograph is taken, and calculates an object speed of the photographing object; an a control section that takes, when the calculated object speed is equal to or higher than a threshold, a photograph at a higher amplification factor of the image signal and in a shorter exposure time, the lens barrel having: a camera shake correcting section that corrects shake of the optical image caused by motion of the imaging apparatus body; and an interface between the camera shake correcting section and the control section of the imaging apparatus body.

### BRIEF DESCRIPTION OF THE DRAWINGS

FIG. 1 is a block diagram showing a configuration of an imaging apparatus according to Embodiment 1 of the present invention;

FIG. 2 shows a schematic configuration of an imaging apparatus according to Embodiment 1;

FIG. 3 is a block diagram showing an example of a configuration of a motion detecting section of the imaging apparatus according to Embodiment 1;

FIG. 4 is an exploded perspective view showing a configuration of a camera shake correcting mechanism in the camera shake correcting section of the imaging apparatus according to Embodiment 1;

FIG. 5 shows a display example of a photographing mode selecting screen displayed on the display section of the imaging apparatus according to Embodiment 1;

FIG. 6 is a flowchart showing photographing processing by the imaging apparatus according to Embodiment 1;

FIG. 7 shows an example of a AF area set in the imaging apparatus according to Embodiment 1;

FIG. 8 illustrates the relationship between the moving speed Vh of the photographing object of the imaging apparatus and photographing sensitivity S upon photographing according to Embodiment 1;

FIG. 9 shows a display example where an image of increased sensitivity and an image without increased sensitivity taken after “photographing sensitivity increasing mode” is set in the imaging apparatus, are displayed on a display section according to Embodiment 1;

FIG. 10 shows a display example where how face detection is carried out is displayed on a display section when an imaging apparatus according to Embodiment 2 of the present invention takes a photograph; and

FIG. 11 is a flowchart showing photographing processing by the imaging apparatus according to Embodiment 2.

### DETAILED DESCRIPTION OF THE PREFERRED EMBODIMENT

Embodiments of the present invention will be explained below in detail, with reference to the accompanying drawings.

### Embodiment 1

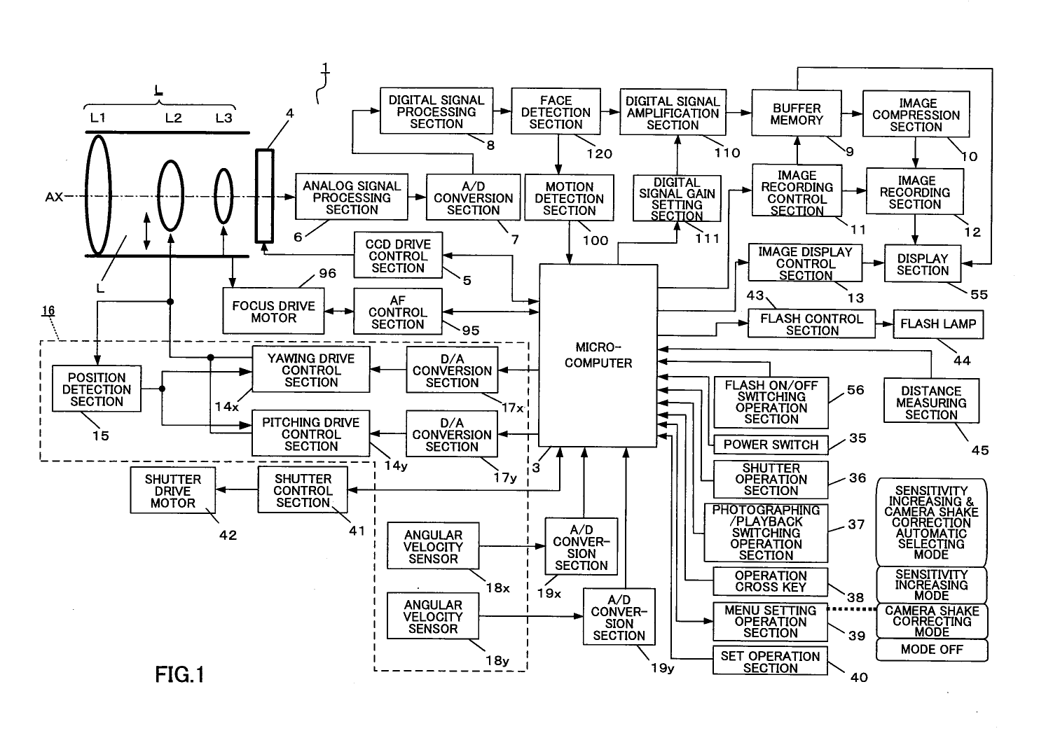

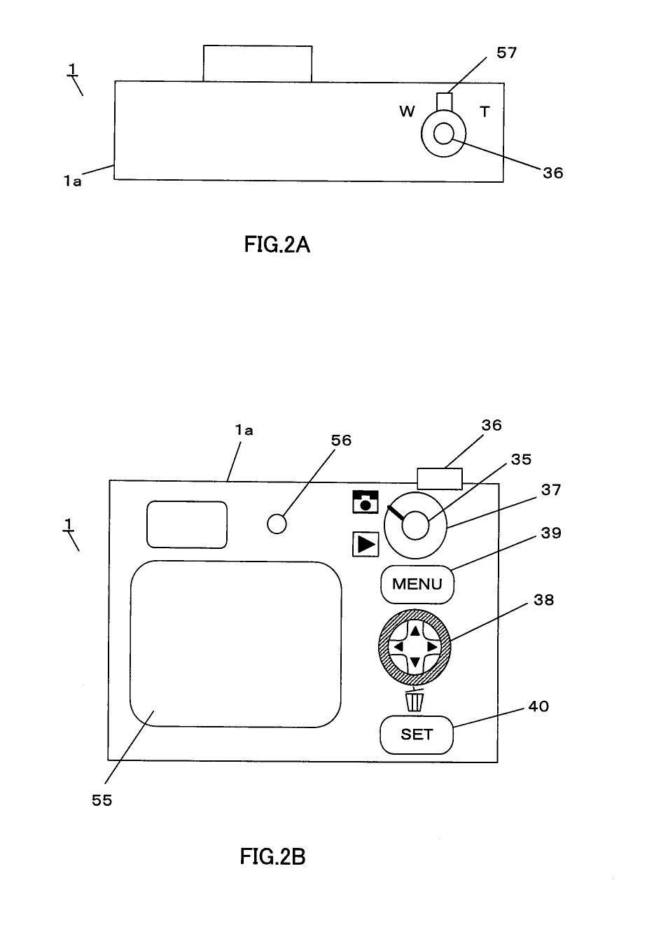

FIG. 1 is a block diagram showing the configuration of an imaging apparatus according to an embodiment of the present invention. FIG. 2 shows a schematic configuration of the imaging apparatus according to the present embodiment, where FIG. 2A shows a top view and FIG. 2B shows a rear view. The present embodiment is an example of a digital camera application with a camera shake correcting function and a photographing sensitivity changing function. In the following explanation, the moving speed of the photographing object (also referred to as “the object speed”) is the moving speed of an optical image of the photographing object in the imaging plane, caused by one of or both of camera shake and object shake.

In FIG. 1, digital camera 1 employs a configuration having an imaging optical system L, microcomputer 3, imaging sensor 4, CCD (Charge Coupled Device) drive control section 5, analog signal processing section 6, A/D conversion section 7, digital signal processing section 8, buffer memory 9, image compression section 10, image record control section 11, image recording section 12, image display control section 13, camera shake correcting section 16, angular velocity sensor 18, display section 55, shutter control section 41, shutter drive motor 42, flash control section 43, flash lamp 44, AF control section 95, focus drive motor 96, motion detecting section 100, digital signal amplification section 110 and digital signal gain setting section 111.

The imaging optical system L is an optical system including three lens groups L1, L2 and L3. The first lens group L1 and the second lens group L2 perform zooming by moving in the direction of the optical axis. The second lens group L2 is a correction lens group that decentralizes the optical axis and corrects the motion of an image by moving in the plane perpendicular to the optical axis. The third lens group L3 performs focusing by moving in the direction of the optical axis. The imaging optical system L is not limited to the above-described optical system configuration.

When mechanical vibration or shake by the photographer is added to digital camera 1, a gap is created between the optical axis of light radiated from the photographing object to the lens and the optical axis of the lens, and, as a consequence, a blurred image is created. Therefore, digital camera 1 has camera shake correcting section 16 and camera shake correcting mechanism 20 to prevent a blurred image from being created. Camera shake correcting section 16 and camera shake correcting mechanism 20 are intended to reduce optical image shake caused by the photographer's shake and vibration added to the camera, for example.

Imaging sensor 4 is, for example, a CCD sensor that converts the optical image formed by the imaging optical system L to electrical signal. Imaging sensor 4 is driven and controlled by CCD drive control section 5. Imaging sensor 4 may be a CMOS (Complementary Metal Oxide Semiconductor) sensor.

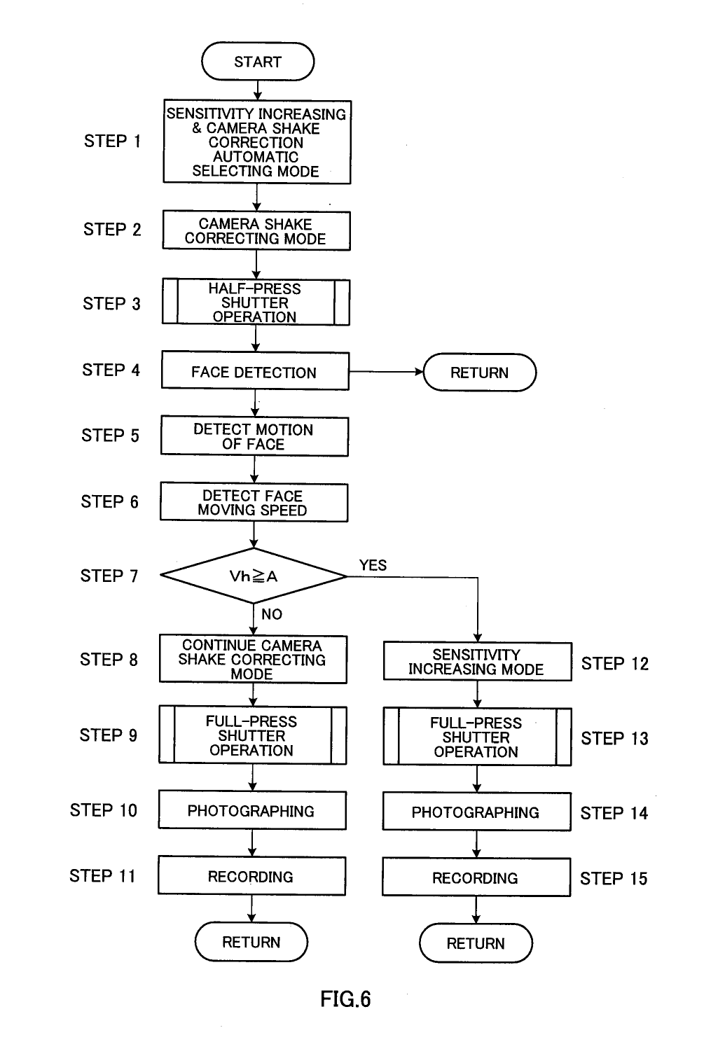

Microcomputer 3 controls the whole of digital camera 1 and also performs photographing control processing of controlling the camera shake correcting function and the photographing sensitivity changing function in accordance with the motion of the photographing object. If the object speed is lower than a threshold, microcomputer 3 controls the camera shake correcting function and starts camera shake correction. If the object speed is equal to or higher than the threshold, microcomputer 3 increases the gain for the photographing sensitivity changing function and makes exposure time short compared to the case where the object speed is lower than the threshold, and takes a plurality of images continuously applying different exposure conditions. Details of the photographing control processing will be described later according to the flowchart in FIG. 6. Furthermore, microcomputer 3 can receive signals from power switch 35, shutter operation section 36, photographing/playback switching operation section 37, operation cross key 38, MENU setting operation section 39 and SET operation section 40. Microcomputer 3 is an example of the control section of the present invention.

In FIG. 2, casing 1a of digital camera 1 is held by the photographer when the photographing object is photographed. Display section 55, power switch 35, photographing/playback switching operation section 37, operation cross key 38, MENU setting operation section 39 and SET operation section 40 are provided in the back of casing 1a.

Power switch 35 is an operation unit for turning on and off power to digital camera 1. Photographing/playback switching operation section 37 is an operation unit for switching between photographing mode and playback mode and allows the photographer to switch between modes by turning a lever. MENU setting operation section 39 is an operation unit for setting various operations of digital camera 1. Operation cross key 38 is an operation unit where the photographer presses the upper, lower, left and right parts and selects desired menu from various menu screens displayed on display section 55. SET operation section 40 is an operation unit for making various menu displays return to the previous display.

In FIG. 2A, shutter operation section 36 and zoom operation section 57 are provided on the top surface of casing 1a. Zoom operation section 57 is provided around shutter operation section 36 and is coaxially rotatable with shutter operation section 36. When the photographer operates photographing/playback switching operation section 37 to switch the mode to photographing mode and turns zoom operation section 57 clockwise, the lens group moves toward the telephoto side, and, when the photographer turns zoom operation section 57 counterclockwise, the lens group moves toward the wide-angle side.

Shutter operation section 36 is, for example, a release button operated by the photographer upon taking a photograph. When shutter operation section 36 is operated, a timing signal is outputted to microcomputer 3. Shutter operation section 36 is a two-stage pushdown switch allowing half-press operation and full-press operation, and, when the photographer performs the half-press operation, shutter operation section 36 starts motion detection, photometric processing and distance measuring processing for the photographing object, which will be described later. When the photographer performs the full-press operation, a timing signal is outputted. Shutter control section 41 drives shutter drive motor 42 according to a control signal outputted from microcomputer 3 which has received the timing signal, and operates the shutter.

Returning to FIG. 1 again, the explanation of the configuration of digital camera 1 will be continued. In FIG. 1, flash control section 43 controls the operation of flash lamp 44. Microcomputer 3, having received the timing signal through the operation of shutter operation section 36, outputs a control signal to flash control section 43. According to this control signal, flash control section 43 makes flash lamp 44 emit light. Flash lamp 44 is controlled according to the amount of light received by imaging sensor 4. That is, if the output of the image signal from imaging sensor 4 is equal to or below a predetermined value, flash control section 43 makes flash lamp 44 work with the shutter operation and emit light automatically. By contrast, if the output of the image signal is equal to or above the predetermined value, flash control section 43 controls flash lamp 44 not to emit light.

Flash ON/OFF operation section 56 is provided to control the operation of flash lamp 44 irrespective of the output of imaging sensor 4 above. That is, flash control section 43 makes flash lamp 44 emit light when flash ON/OFF operation section 56 is turned on, and does not make flash lamp 44 emit light when flash ON/OFF operation section 56 is turned off.

The image signal outputted from imaging sensor 4 is sent from analog signal processing section 6 to A/D conversion section 7, digital signal processing section 8, digital signal amplification section 110, buffer memory 9 and image compression section 10 in sequence and processed. Analog signal processing section 6 applies analog signal processing such as gamma processing, to the image signal outputted from imaging sensor 4. A/D conversion section 7 converts the analog signal outputted from analog signal processing section 6 to a digital signal. Digital signal processing section 8 applies digital signal processing such as noise cancellation and contour emphasis to the image signal converted to the digital signal by A/D conversion section 7 and outputs the signal to motion detecting section 100 and digital signal amplification section 110. Buffer memory 9 is a RAM (Random Access Memory) and stores the image signal on a temporary basis.

Digital signal gain setting section 111 sets the amplification gain for the image signal after digital signal processing. Digital signal amplification section 110 amplifies the image signal using the set amplification gain and outputs the signal to buffer memory 9. The setting of amplification gain is equivalent to setting photographing sensitivity. With the present embodiment, photographing sensitivity is expressed in values equivalent to ISO sensitivity and can be set equivalent to photographing sensitivity of ISO80, 100, 200, 400, 800 and 1600, for example. Here, photographing sensitivity that can be set is not limited to these. Furthermore, photographing sensitivity may be expressed in values other than ISO sensitivity equivalents.

Furthermore, the processing of amplifying an image signal is not necessarily performed in digital signal amplification section 110 and may be performed on an analog signal in analog signal processing section 6. Furthermore, the amplification processing may be performed in imaging sensor 4.

The image signal stored in buffer memory 9 is sent from image compression section 10 to image recording section 12 in sequence and processed. The image signal stored in buffer memory 9 is read out according to a command from image record control section 11 and transmitted to image compression section 10. Data of the image signal transmitted to image compression section 10 is compressed to image signal according to a command from image record control section 11. Through this compression processing, the image signal is reduced to a smaller data size than source data. For example, the JPEG (Joint Photographic Experts Group) scheme is used as the compression method. After that, the compressed image signal is recorded in image recording section 12 by image record control section 11.

Image recording section 12 is, for example, a built-in memory and/or a detachable, removable memory that records the image signal in association with predetermined information to be recorded, based on the command of image record control section 11. The predetermined information to be recorded together with the image signal includes the date and time the image is taken, focal length information, shutter speed information, F-number information and photographing mode information. The predetermined information is given, for example, in the Exif (registered trademark) format or similar formats to the Exif format.

Display section 55 displays an image signal recorded in image recording section 12 or buffer memory 9 in visible image, according to a command from image display control section 13. Here, the display mode of display section 55 includes a display mode in which only image signals are displayed in visible image, and a display mode in which image signals and information upon photographing are displayed in visible images.

AF control section 95 adjusts focus by driving the third lens group L3 through focus drive motor 96 in the optical axis AX direction. Face detection section 120 performs face detection processing on a plurality of photographing objects, and microcomputer 3 performs automatic focusing processing by setting AF areas upon the detected faces of the photographing objects. The AF areas are not limited to the faces of the photographing objects and may be set upon eyes, nose, mouth and so on. Furthermore, the sex and age of the photographing object, or whether or not the photographing object is an animal, is decided by extracting features of the face.

AF control section 95 detects the state of focus in each AF area and calculates an optimum focusing position for the principal photographing object.

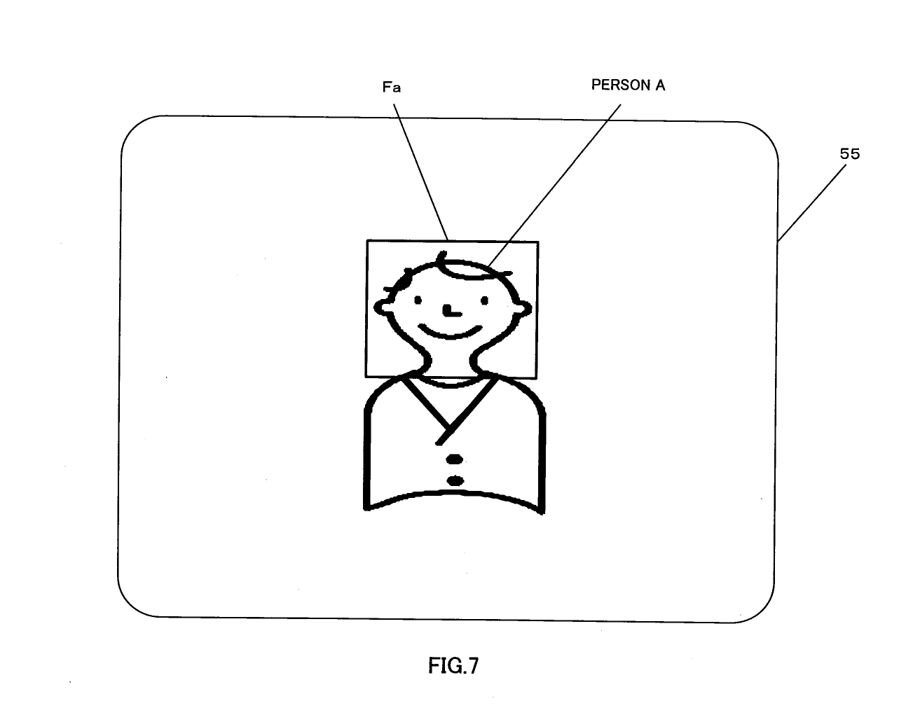

FIG. 7 shows an example of a AF area set by digital camera 1. In FIG. 7, AF area Fa is set with a solid line in a predetermined position in the photographing screen where the face of photographing object (person A) is detected.

Focus drive motor 96 moves the third lens group L3, which is a focus lens, in the optical axis direction, and determines the position of the third lens group L3 where the contrast value in AF area Fa becomes a maximum. The contrast value is obtained by calculating with microcomputer 3 changes in light and dark from the image signal corresponding to the AF area Fa. AF control section 95 calculates an optimum focusing position for the principal photographing object from, example, the magnitude of the contrast value of AF area Fa and weight based on the position of the AF area Fa in the photographing screen. Therefore, the photographer can check in which part on the photographing screen focus is set, from the displayed AF area Fa.

Motion detecting section 100 detects, on a per frame basis, a vector (hereinafter “motion vector”) showing the amount of position shift in the horizontal and vertical directions of the image between frames, based on the image signal converted to a digital signal in AF area Fa. Hereinafter, the details of motion detecting section 100 will be explained.

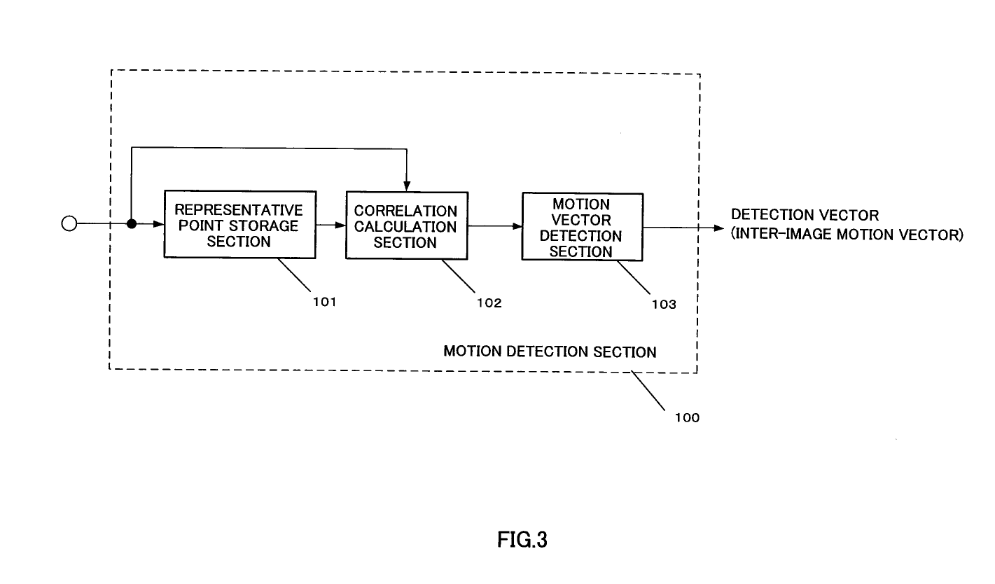

FIG. 3 is a block diagram showing an example of the configuration of above-described motion detecting section 100. In FIG. 3, motion detecting section 100 employs a configuration including representative point memory 101, correlation calculation section 102 and motion vector detecting section 103.

Representative point memory 101 divides the image signal of the current frame inputted via A/D conversion section 7 and digital signal processing section 8 into a plurality of segments, and stores image signals corresponding to the specific representative points included in each segment as representative point signals. Furthermore, representative point memory 101 reads out the representative point signals in one frame earlier than the current frame that is already stored, and outputs the signals to correlation calculation section 102.

Correlation calculation section 102 calculates the correlations between the representative signal points of one frame earlier and the representative signal points of the current frame, and determines the differences between the representative signal points. The calculation result is outputted to motion vector detecting section 103.

Motion vector detecting section 103 detects the motion vector of the image between the previous frame and the current frame on a per pixel basis, from the calculation result by correlation calculation section 102. The motion vector is then outputted to microcomputer 3. Microcomputer 3 adjusts the gain and phase of the motion vector and calculates the moving direction and speed of the photographing object in the image signal per unit time.

The processing of detecting the motion of the photographing object is started by, for example, the half-press operation of shutter operation section 36 by the photographer. The start of the processing may also be synchronized with the operation of turning on power switch 35 and switching to photographing mode by operating photographing/playback switching operation section 37 by the photographer.

Next, the configuration of camera shake correcting section 16 which implements the camera shake correcting function will be explained. Camera shake correcting section 16 includes position detecting section 15, yawing drive control section 14x, pitching drive control section 14y, D/A conversion sections 17x and 17y, angular velocity sensors 18x and 18y and A/D conversion sections 19x and 19y.

Yawing drive control section 14x and pitching drive control section 14y drive the correction lens group L2 in two directions perpendicular to the optical axis AX of the imaging optical system L. Position detecting section 15 detects the position of the correction lens group L2. Above-described position detecting section 15, yawing drive control section 14x and pitching drive control section 14y form a feedback control loop for driving and controlling the correction lens group L2.

Angular velocity sensors 18x and 18y are sensors for detecting the motion of digital camera 1 including the imaging optical system L. Angular velocity sensors 18x and 18y output positive and negative angular velocity signals depending on the direction the digital camera moves, based on the output in a state where digital camera 1 is still. In the present embodiment, two angular velocity sensors are provided for detecting the two directions of the yawing direction and the pitching direction.

The outputted angular velocity signal is converted into a digital signal by A/D conversion sections 19x and 19y via filtering processing and amplification processing, and the result is provided to microcomputer 3. Microcomputer 3 applies filtering, integration processing, phase compensation, gain adjustment and clipping processing to the angular velocity signal in sequence, calculates the amount of drive control of the lens group L2 required for camera shake correction and outputs the calculation result as a control signal. Such a control signal is outputted to yawing drive control section 14x and pitching drive control section 14y through D/A conversion sections 17x and 17y.

Yawing drive control section 14x and pitching drive control section 14y drive the correction lens group L2 by a predetermined amount of drive, according to the control signal, so that it is possible to correct camera shake and reduce image quality degradation.

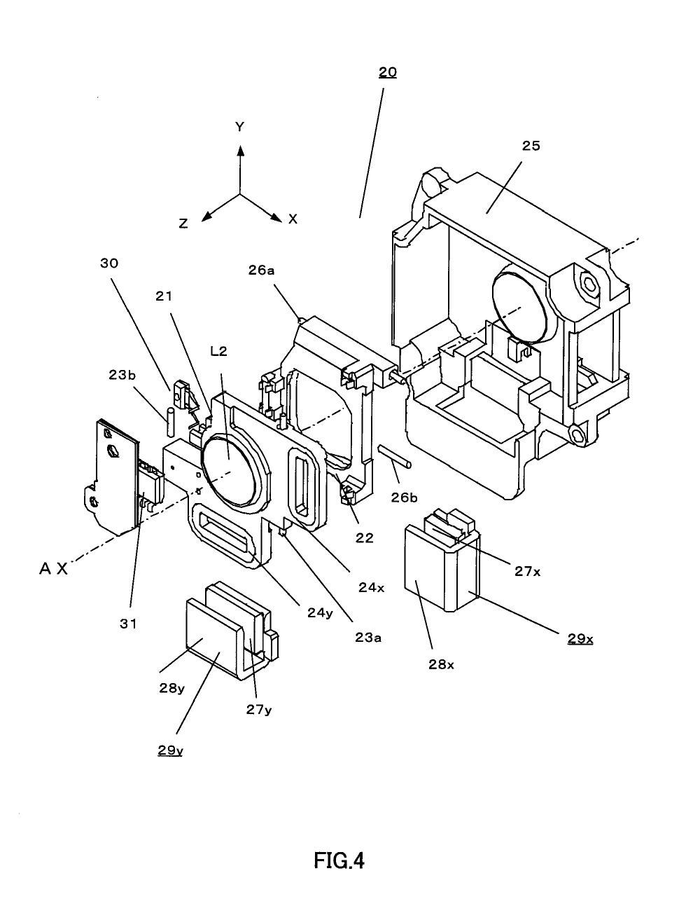

FIG. 4 is an exploded perspective view showing the configuration of camera shake correcting mechanism 20 incorporated in camera shake correcting section 16 described above.

Camera shake correcting mechanism 20 employs a configuration comprised mainly of pitching move frame 21, yawing move frame 22, pitching shafts 23a and 23b, coils 24x and 24y, fixing frame 25, yawing shafts 26a and 26b, magnets 27x and 27y, yokes 28x and 28y, actuators 29x and 29y, light emitting element 30 and light receiving element 31.

The correction lens group L2 is fixed to pitching move frame 21. Pitching move frame 21 is held to yawing move frame 22 to be slidable in the Y direction through two pitching shafts 23a and 23b. Furthermore, coils 24x and 24y are fixed to pitching move frame 21. Yawing move frame 22 is held to be slidable in the X direction to fixing frame 25 through yawing shafts 26a and 26b. Magnet 27x and yoke 28x are held to fixing frame 25 and configure actuator 29x with coil 24x. In the same way, magnet 27y and yoke 28y are held to fixing frame 25 and configure actuator 29y with coil 24y. Light emitting element 30 is fixed to pitching move frame 21. Furthermore, light receiving element 31 is fixed to fixing frame 25, receives light emitted from light emitting element 30 and detects a two-dimensional position coordinate. Such light emitting element 30 and light receiving element 31 configure above-described position detecting section 15.

The operation of digital camera 1 having a camera shake correcting function and a photographing sensitivity changing function configured as shown above will be explained below.

First, selectable photographing modes of digital camera 1 will be explained. Photographing modes include, for example, “continuous shooting mode” in which shutter drive motor 42 is operated at 0.3 second intervals and two or more photographs are taken continuously, “sensitivity increasing and camera shake correction automatic selecting mode,” “sensitivity increasing mode” and “camera shake correcting mode,” which will be described later, and the photographer can select a desired photographing mode. When the photographing mode is selected, microcomputer 3 controls various control sections according to that photographing mode.

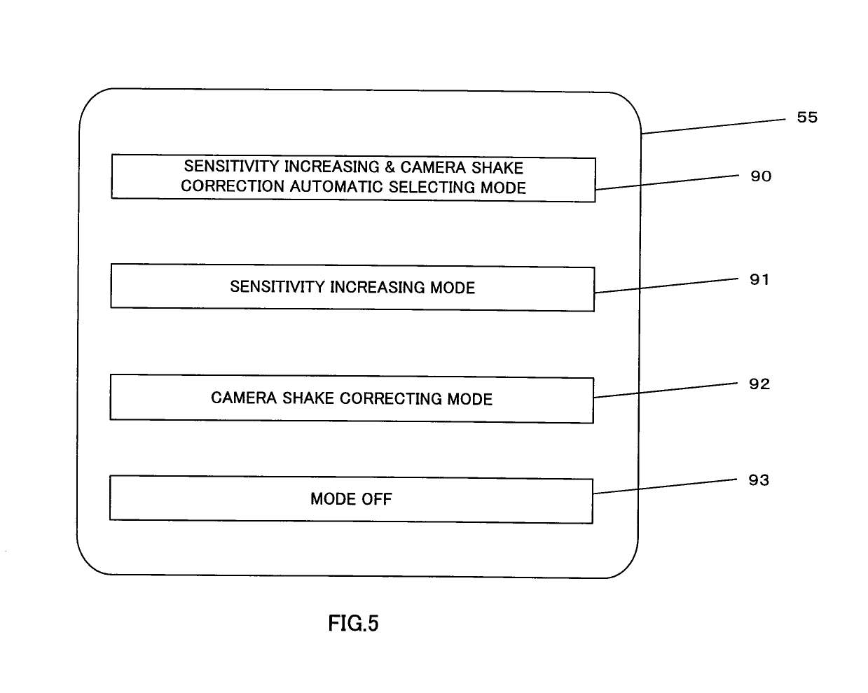

FIG. 5 illustrates a display example of an photographing mode selecting screen displayed on display section 55. The photographing mode selecting screen can be displayed on display section 55 by the photographer operating MENU setting operation section 39 or operation cross key 38. As shown in FIG. 5, photographing modes include “sensitivity increasing & camera shake correction automatic selecting mode,” “sensitivity increasing mode,” “camera shake correcting mode” and “mode OFF,” and the photographer can set a desired photographing mode by selecting between respective associated icons 90 to 93. FIG. 5 shows only characteristic photographing mode selecting icons of the present embodiment, but icons for selecting other photographing modes such as “continuous shooting mode” above may be further displayed.

When sensitivity increasing mode selecting icon 91 is selected, the photographing sensitivity is changed to higher sensitivity (“sensitivity increasing mode”) than for normal photography. That is, digital signal amplification section 110 amplifies an image signal by a predetermined gain according to a command from microcomputer 3. In this way, it is possible to make exposure time shorter and take a photograph at a higher shutter speed, and, consequently, reduce the influence of image shake.

When camera shake correcting mode selecting icon 92 is selected, the camera shake correcting function (“camera shake correcting mode”) is started. That is, camera shake correcting mechanism 20 reduces camera shake by driving the correction lens group L2 in two directions in the plane perpendicular to the optical axis according to a command from microcomputer 3.

When sensitivity increasing & camera shake correction automatic selecting mode icon 90 is selected, microcomputer 3 automatically switches the mode to either “sensitivity increasing mode” or “camera shake correcting mode” according to the moving speed of the photographing object. In this way, when the photographing object moves at such speed that causes object shake, high photographing sensitivity is set, whereas, when the photographing object moves at such slow speed that does not cause object shake, the camera shake correcting function for reducing image shake by camera shake is started.

When mode-off selecting icon 93 is selected, the above-described photographing sensitivity increasing function and the camera shake correcting function do not operate and a photograph is taken in normal mode.

Next, the photographing processing for when “sensitivity increasing & camera shake correction automatic selecting mode” is selected, will be explained using the flowchart of FIG. 6.

FIG. 6 is a flowchart showing the photographing processing of digital camera 1 executed by microcomputer 3. This flow starts when power switch 35 of digital camera 1 is operated “on.”

In the processing in step 1, when the photographer operates MENU setting operation section 39 provided in the back of casing 1a of digital camera 1, a list of photographing modes is displayed on display section 55. When the photographer selects sensitivity increasing & camera shake correction automatic selecting mode icon 90 amongst the photographing mode selecting icons displayed, the process moves to step 2 and “camera shake correcting mode” is started.

In step 2, microcomputer 3 changes the photographing mode to “camera shake correcting mode” and starts camera shake correcting section 16 and camera shake correcting mechanism 20. Camera shake correcting section 16 detects camera shake occurring with the camera through angular velocity sensors 18x and 18y. According to a command from microcomputer 3, a current is supplied to coils 24x and 24y of pitching move frame 21 from an external circuit and the magnetic circuit comprised of actuators 27x and 27y makes pitching move frame 21 and the correction lens group L2 move in two directions X and Y in the plane perpendicular to the optical axis AX. In this case, light receiving element 31 detects the position of pitching move frame 21, thereby enabling position detection with high accuracy.

In step 3, microcomputer 3 recognizes that the photographer has operated shutter operation section 36, and microcomputer 3 moves the process to step 4.

In step 4, the face of the photographing object is detected. As one face detection method, there is a method of detecting contour information from the photographed image and detecting whether or not there are features (e.g., eyes, nose, mouth, etc.) with the detected contour. When the detected contour shows features, face detection section 120 decides that there is a face.

Instep 5, the motion of the face of the photographing object is detected. In the face motion detecting processing, motion detecting section 100 detects the motion of the object to be photographed by tracking the representative points of the photographed image, and outputs a motion vector. Furthermore, photometric measuring processing and distance measuring processing are performed at the same time with the motion detecting processing. In the photometric measuring processing, digital signal processing section 8 calculates the exposure value based on the image signal outputted from imaging sensor 4. Microcomputer 3 automatically sets adequate shutter speed based on the calculated exposure value. Furthermore, in the distance measuring processing, a focus control section (not shown) adjusts focus by moving the lens groups in the optical axis directions such that the contrast value of the image signal shows a peak. On the other hand, when a face cannot be detected as a photographing object, “sensitivity increasing & camera shake correction automatic selecting mode” is terminated and photography in normal “camera shake correcting mode” is continued.

Furthermore, when the motion of the face of the photographing object is detected, since camera shake is corrected, the motion can be detected in a state of reduced influence of camera shake, so that the accuracy of motion detection can be improved. That is, it is possible to decide whether the motion of the image in imaging sensor 4 is caused by the motion of the photographing object or is influenced by the motion of the camera caused by camera shake by the photographer.

In step 6, microcomputer 3 calculates the moving speed Vh of the face of the photographing object per unit time from the motion vector detected by motion detection section 100.

In step 7, the moving speed Vh is identified. A threshold A is registered in advance in digital camera 1, and microcomputer 3 compares the moving speed Vh with the threshold A. Here, this threshold A represents a threshold at which object shake occurs and may be a camera-specific value or may be arbitrarily set by the photographer. For example, when the flash lamp is used, shutter speed can be made faster, so that photographing sensitivity is not increased more than necessary by increasing the threshold. By contrast, when taking a photograph of a child or pet who/which does not stay still as a photographing object, it is also possible to adopt a method of providing digital camera 1 with child photographing mode or pet photographing mode separately, so that, when the photographer selects that mode, the threshold is decreased and priority is given to increasing of the photographing sensitivity. Furthermore, even when the distance to the photographing object is too far for the flash lamp light to reach or if the focal length of digital camera 1 is long and the influence of camera shake is significant, the threshold may be decreased according to the distance to the photographing object or focal length to give priority to photographing sensitivity. If the comparison result shows that the moving speed Vh is equal to or higher than the threshold A, microcomputer 3 decides that the photographing object is moving at a speed that causes object shake, and moves the process to step 12. When the moving speed Vh is lower than the threshold A, microcomputer 3 decides that object shake does not occur, and moves the process to step 8. In the situation where object shake does not occur, ISO sensitivity, which is photographing sensitivity, is set to 64 or equivalent and the shutter speed is set to 1/30 second.

In step 8, microcomputer 3 continues “camera shake correcting mode” as the photographing mode and starts camera shake correcting section 16 and camera shake correcting mechanism 20. Camera shake correcting section 16 detects camera shake occurring on the camera through angular velocity sensors 18x and 18y. According to command from microcomputer 3, a current is supplied to coils 24x and 24y of pitching move frame 21 from an external circuit, and, by a magnetic circuit comprised of actuators 27x and 27y, pitching move frame 21 and the correction lens group L2 move in two directions X and Y in the plane perpendicular to the optical axis AX. In this case, light receiving element 31 detects the position of pitching move frame 21, thereby enabling position detection with high accuracy.

If, in step 9, microcomputer 3 recognizes the full-press operation in shutter operation section 36 by the photographer, microcomputer 3 performs photographing processing in step 10. That is, a photographing object image is formed in imaging sensor 4, an image signal is outputted, and the outputted image signal is displayed on display section 55.

In step 11, microcomputer 3 records the image signal in image recording section 12 and finishes the photographing processing. Furthermore, when the image signal is recorded, the position of the AF area Fa with respect to the whole of the photographed image, is also recorded. Photographing is not limited to a single shot alone and continuous shooting may be performed as well.

FIG. 7 shows a display example where a photographed image is displayed on display section 55. As shown in FIG. 7, display section 55 displays ISO sensitivity, which is photographing sensitivity, with the photographed image.

In this way, when the moving speed Vh of the face of the photographing object is lower than the threshold A, photographing sensitivity is not changed and the camera shake correcting function is started. This reduces camera shake and allows an image of high quality to be taken.

On the other hand, when the moving speed Vh is equal to or higher than the threshold A in step 7 above, microcomputer 3 changes the photographing mode to “sensitivity increasing mode.” That is, digital signal gain setting section 111 sets gain so as to achieve high photographing sensitivity. Here, microcomputer 3 sets the photographing speed according to the moving speed of the face of the photographing object. Therefore, microcomputer 3 calculates shutter speed that will not cause object shake from the moving speed Vh of the face of the photographing object, and sets photographing sensitivity at which the object can be photographed applying that shutter speed. For example, in an outdoor environment, photographing sensitivity is set according to the moving speed of the face of the photographing object, such that photographing sensitivity is set equivalent to ISO sensitivity 100 when the photographing object is moving slowly at a walking pace or set equivalent to ISO sensitivity 400 when the photographing object is moving at a running pace.

If, in step 13, microcomputer 3 recognizes the full-press operation in the shutter operation section by the photographer, photographing processing is carried out in step 14 or later. That is, in step 14, an optical image of the photographing object is formed in imaging sensor 4 and imaging sensor 4 outputs the image signal. Digital signal amplification section 110 then amplifies the image signal outputted from digital signal processing section 8 at the gain set in step 12.

In step 15, the amplified image signal is recorded in image recording section 12 and thereupon the photographing processing is finished. Furthermore, when the image signal is recorded, the position of AF area Fa with respect to the whole of the photographed image is also recorded. Photographing is not limited to a single shot alone and continuous shooting may be performed as well.

FIG. 7 also shows a display example where an image photographed in “camera shake correcting mode” is displayed on display section 55. Although not shown in FIG. 7, display section 55 may display ISO sensitivity, which is photographing sensitivity, with the photographed image.

In this way, when the moving speed Vh of the face of the photographing object is equal to or higher than the threshold A, high photographing sensitivity is set. By this means, the exposure time can be made shorter and a photograph can be taken at a high shutter speed, so that object shake can be prevented. In photographing sensitivity increasing mode, the camera shake correcting mechanism may or may not be operated.

As described above, the present embodiment calculates the object speed based on the motion of the face of the detected photographing object, decides whether or not the object speed is equal to or higher than a threshold A, and, if the object speed is lower than the threshold A, starts camera shake correction by controlling camera shake correcting section 16, and, if the object speed is equal to or higher than the threshold A, increases the gain of digital signal gain setting section 111, increases ISO sensitivity and/or increases the shutter speed and shortens exposure time, so that it is possible to reduce image quality degradation due to camera shake or object shake and easily take a photograph in good image quality.

More specifically, if the motion of the face of the photographing object is fast, the photographing sensitivity is changed to high photographing sensitivity, exposure time is made shorter and a photograph is taken at a high shutter speed. This prevents image quality degradation due to object shake. In addition, if the motion of the face of the photographing object is slow, camera shake correcting section 16 is started, so that it is possible to prevent camera shake and reduce image quality degradation. This allows the photographer to easily take a photograph independently of the motion of the photographing object.

Furthermore, since the present embodiment automatically changes photographing sensitivity to high sensitivity when the motion of the face of the photographing object is fast, the photographer needs not observe the motion of the photographing object to decide whether or not object shake occurs, thereby offering an improved level of convenience.

Furthermore, the present embodiment changes photographing sensitivity to high sensitivity when the detected object speed is equal to or higher than the threshold A. This prevents the photographer from mistakenly setting high photographing sensitivity even if the photographing object is moving at a speed which does not cause object shake.

Especially, the present embodiment, placing focus upon the motion of the face of the photographing object among the motions of the photographing object, instead of detecting all motions of the photographing object, starts camera correcting section 16 when the motion of the face of the photographing object is slow or changes the photographing sensitivity to high sensitivity when the motion of the face of the photographing object is fast, thereby switching from camera shake correction control to photographing sensitivity control in high photographing sensitivity in accordance with the motion of the face of the photographing object which the photographer wants to photograph in an optimal manner. Therefore, even if the moving speed of part or the whole of the detected photographing object is equal to or higher than the threshold A, as long as the motion of the face of the photographing object is lower than the threshold A, “camera shake correcting mode” is continued and does not change to “sensitivity increasing mode.” That is, “camera shake correcting mode” is continued as long as possible until the motion of the face of the photographing object reaches or exceeds the threshold A, and the mode is changed to “sensitivity increasing mode” only when the motion of the face of the photographing object reaches or exceeds the threshold A. In the situation where the face of the photographing object does not move much, for example, when the photographing object is a person and that person is waving his/her hand, the mode is not shifted to “sensitivity increasing mode,” thus preventing the photographing sensitivity from being increased more than necessary. When the object speed is low, it is possible to prevent image quality degradation occurring when the object speed is slow and ISO sensitivity is increased. Since the photographer considers it best to take a photograph of the face, the ISO sensitivity is not increased if the face does not move. This control can be easily set/canceled by the user on the photographing mode selecting screen shown in FIG. 5. Furthermore, it is also possible to further add a menu for changing photographing sensitivity to high sensitivity to this photographing mode selecting screen according to the motion of the photographing object.

The photographing control of the present embodiment proves particularly effective upon use on occasions like telephotography in athletic meets.

By determining photographing sensitivity by detecting the motion of the face of the photographing object, it is not necessary to increase photographing sensitivity more than necessary, if, for example, the object's hand or leg moves, thereby preventing image quality degradation caused by increased photographing sensitivity.

Here, the relationship between the change of speed of the photographing object and photographing sensitivity from “half-press shutter operation” to “full-press shutter operation,” up to photographing, will be explained.

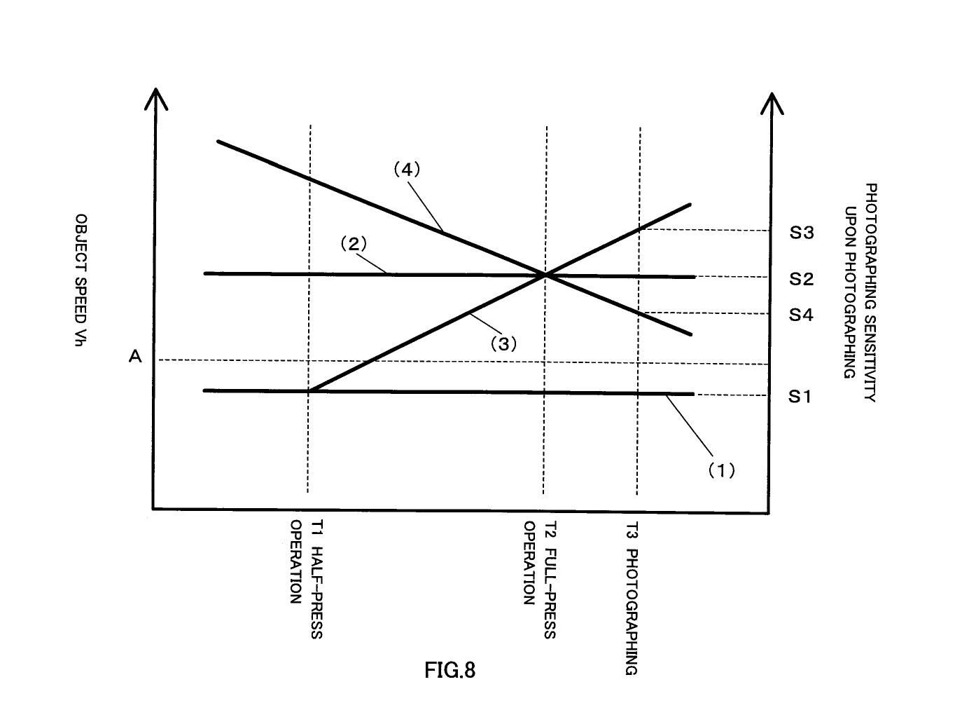

FIG. 8 illustrates the relationship between the moving speed Vh of the photographing object and the photographing sensitivity S upon photographing. In FIG. 8, T1 is the half-press operation, T2 is the full-press operation and T3 is the time a photograph is taken. Furthermore, S1 to S4 represent photographing sensitivity upon photographing, and A represents a threshold. When it is decided whether the object speed Vh is equal to or higher than the threshold A, if the object speed is lower than the threshold A, the speed of camera shake correcting section 16 is increased, and, if the object speed is equal to or higher than the threshold A, ISO sensitivity is increased and the shutter speed is increased.

The present embodiment starts motion vector detection in synch with the “half-press shutter operation” (step 4 of the flowchart in FIG. 6). Motion vector detection is performed at regular intervals until immediately before the “full-press shutter operation” (steps 8 and 12 in the flowchart of FIG. 6) and the speed of the photographing object at the time of the “full-press shutter operation” is assumed to be the definitive speed of the photographing object Vh. In this case, in FIG. 8, (1) shows a case where the photographing object does not move, (2) shows a case where the photographing object is moving at a constant speed, (3) shows a case where the photographing object is accelerating at a predetermined rate and (4) shows a case where the photographing object is decelerating at a predetermined rate. The relationship between speed change of the photographing object and photographing sensitivity will be described as follows.

(1) When the object speed Vh during the “half-press shutter operation” is lower than the threshold A and is constant, the object speed Vh is lower than the threshold A, and, consequently, photographing sensitivity is not increased and photographing sensitivity S1 for normal photographing mode is adopted.

(2) When the object speed Vh during the “half-press shutter operation” is higher than the threshold A and is constant, photographing sensitivity is increased according to the object speed Vh during the “full-press shutter operation.” In this case, photographing sensitivity is set to S2.

(3) When the object speed Vh during the “half-press shutter operation” exceeds the threshold A and increases gradually, since the object speed Vh increases gradually, the acceleration is calculated and sensitivity is set to photographing sensitivity S3 (S2<S3) by predicting the speed increase in the time lag between the “full-press shutter operation” and photographing.

(4) When the object speed Vh during the “half-press shutter operation” exceeds the threshold A and slows down gradually, contrary to the above case (3), when the object speed Vh slows down gradually, sensitivity is set to photographing sensitivity S4 (S4<S2) by predicting the decrease of speed.

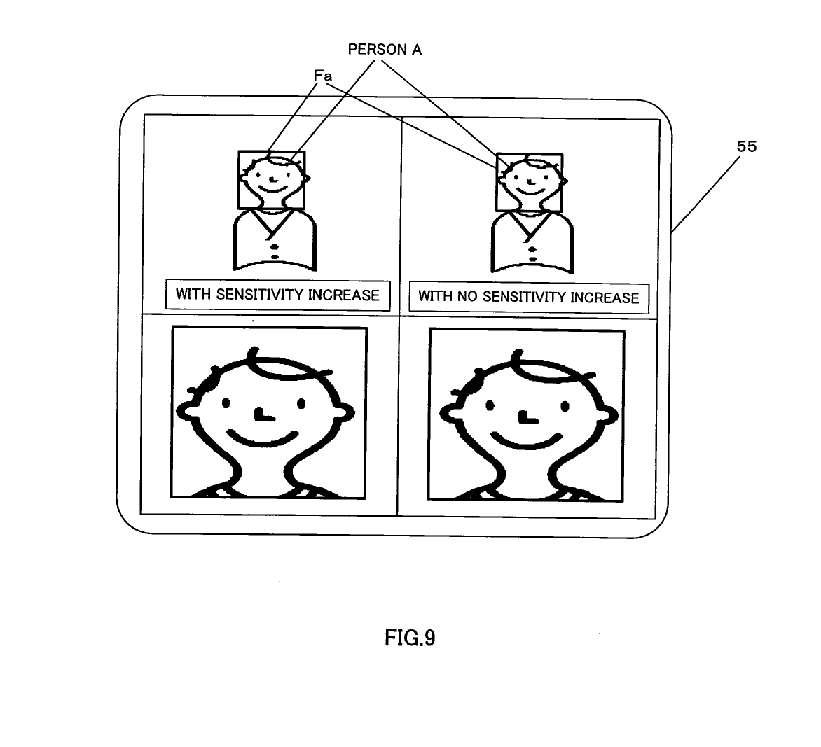

FIG. 9 shows a display example where an image taken with increased sensitivity after “photographing sensitivity increasing mode” of the imaging apparatus according to the present embodiment is set and an image taken without increased sensitivity, are displayed in a display section.

Furthermore, as shown in FIG. 9, by continuously taking photographs in one shutter operation and taking photographs in varying photographing sensitivities, that is, by taking photographs with increased sensitivity and without increased sensitivity, photographs taken in the above two modes and their image quality may be compared in a simple manner immediately after photographing or upon playback. Furthermore, four photographed images may be displayed in display section 55 at the same time by automatically or manually enlarging the images using operation cross key 38 or the like.

Furthermore, when two photographed images are recorded, both images may be recorded or the photographer may be allowed to select one image and erase the unnecessary one.

Furthermore, when a photographed image is played back, the whole of the image may be displayed or an enlarged view at arbitrary zoom factor may be displayed around the center of the AF area Fa recorded in the photographed image.

Furthermore, an upper limit to photographing sensitivity may be set to reduce quality degradation of photographed images.

Furthermore, upon taking a photograph using a self-timer, the motion of an optical image of the photographing object maybe detected from several seconds before a photograph is taken, after shutter operation section 36 is pressed full. Still better, an LED may be provided in the front of digital camera 1 to blink during motion detection, so that the photographing object can recognize this.

### Embodiment 2

A case will be explained below with Embodiment 2 where the motion of the faces of a plurality of photographing objects are detected and the photographing mode is set.

The hardware configuration of the imaging apparatus according to Embodiment 2 of the present invention is substantially the same as shown in FIGS. 1 to 3, and so the explanations will be omitted.

The digital camera according to the present embodiment differs from the digital camera according to Embodiment 1 in making possible selecting an arbitrary photographing object from a plurality of photographing objects, detecting the motion of the face of the selected photographing object and selecting a photographing mode. The same components as in Embodiment 1 will be assigned the same reference numerals and explanations will be focused upon points different from Embodiment 1.

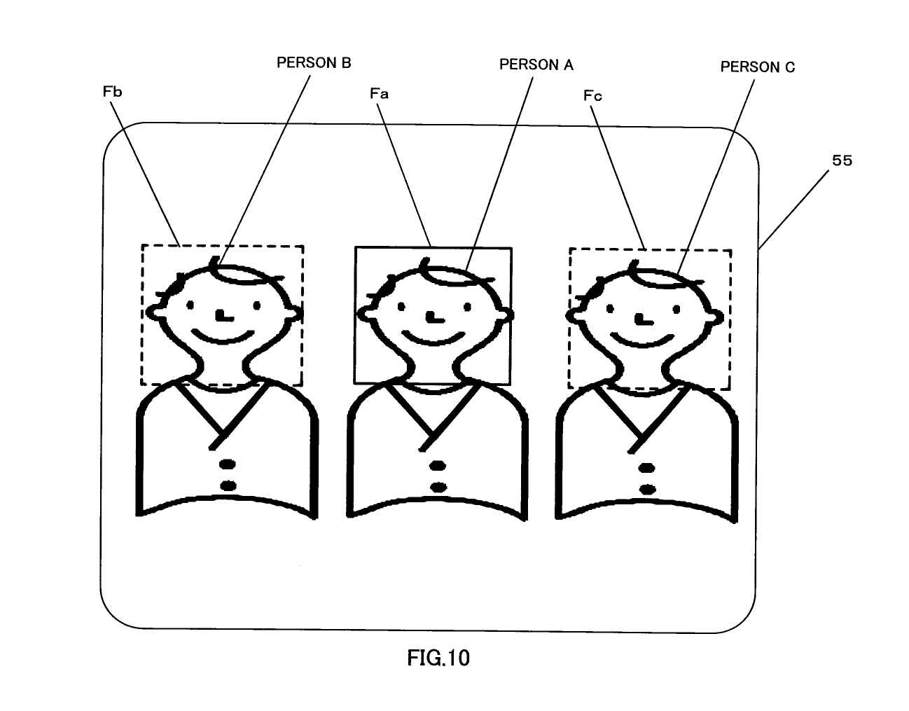

FIG. 10 shows a display example where how face detection is carried out for a plurality of children is displayed on display section 55 when a photograph is taken. In FIG. 10, AF areas Fa, Fb and Fc are set in predetermined positions in the shot screen where the faces of a plurality of photographing objects, namely child a, child b and child c, are detected. In this case, these AF areas are assigned preferentially to the photographing objects of children. In the present embodiment, AF areas with high priority are shown with solid lines and the rest is shown with dotted lines. Furthermore, with respect to motion detection of the photographing objects, the AF areas shown with solid lines are given priority.

Since the AF area of a solid line is set in the face of person A in FIG. 10, the motion of the face of person A is given priority in motion detection. Furthermore, as for the priority of the measurement area, the measurement area may be set automatically upon the photographing object in the center or may be selected freely by the photographer. When the photographer makes selections, the photographer can move the AF area to be given priority, by pressing the left or right part of operation cross key 38. When the left part of operation cross key 38 is pressed, the person to be given priority is changed to person B and AF area Fb is changed to a solid line. On the other hand, when the right part of operation cross key 38 is pressed, the person to be given priority is changed to person C, and AF area Fc is changed to a solid line. Furthermore, as for the photographing object to be given priority, digital camera 1 may store information about the face of a specific person beforehand and automatically give priority to that person, when the detected face matches the recorded face information, and such a system is very effective when taking a photograph of the photographer's child, for example. The number of AF areas is not limited to three and may be greater than that. Furthermore, face detection section 120 may detect how much photographing objects are smiling, and give priority to the photographing object smiling the most from person A, person B and person C and select the photographing object for the AF area.

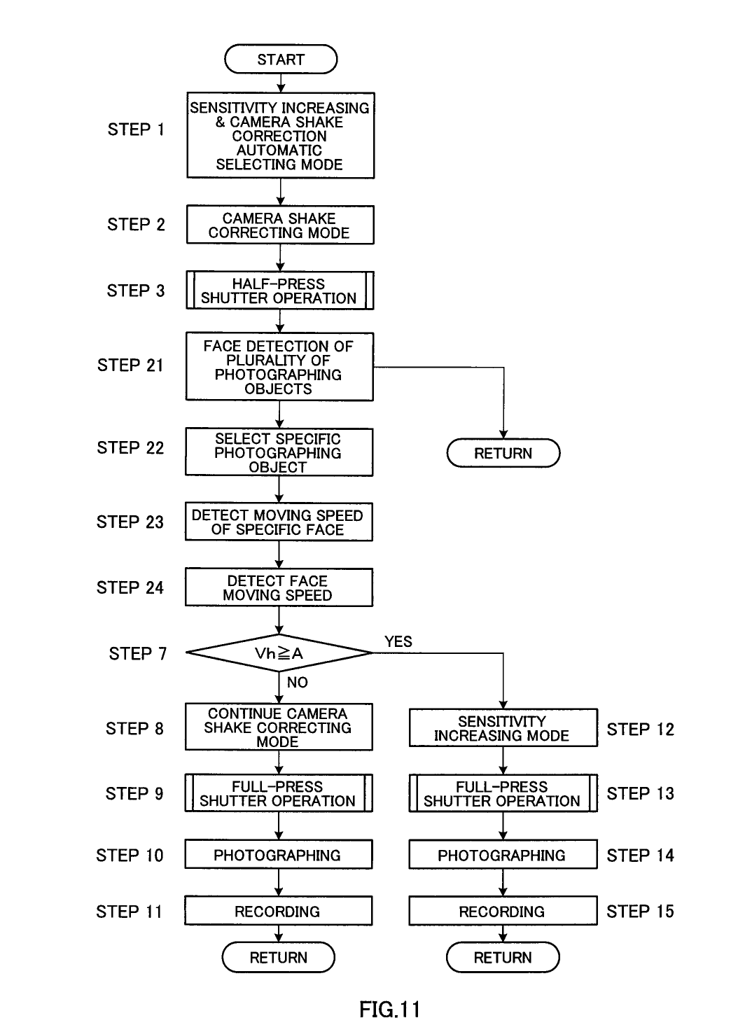

Next, the photographing processing for when “sensitivity increasing & camera shake correction automatic selecting mode” is selected, will be explained using the flowchart of FIG. 11.

FIG. 11 is a flowchart showing photographing processing by digital camera 1 and steps carrying out the same processes as in the flow shown in FIG. 6 are assigned the same step numbers and overlapping explanations will not be repeated.

Upon recognizing in step 3 that the photographer has operated shutter operation section 36, the process moves to step 21.

Instep 21, the faces of a plurality of photographing objects are detected, and, in step 22, a specific photographing object is selected from among the plurality of photographing objects. For example, person A in FIG. 9 is selected. Here, in the processes in steps 21 and 22, photometric processing and distance measurement processing are performed simultaneously with face detection. In the photometric processing, digital signal processing section 8 calculates the exposure value based on the image signal outputted from imaging sensor 4. Microcomputer 3 automatically sets adequate shutter speed based on the calculated exposure value. Furthermore, in the distance measuring processing, a focus control section (not shown) adjusts focus by moving the lens groups in the optical axis directions such that the contrast value of the image signal shows a peak. Here, if the face cannot be detected as the photographing object, “sensitivity increasing & camera shake correction automatic selecting mode” is terminated and photography in normal “camera shake correcting mode” is continued.

In step 23, the motion of the face of a specific photographing object is detected. The face of the specific photographing object is identified by photographing the faces of specific photographing objects in advance and registering the data in a memory, and, when a photograph is to be taken, the photographing object is compared with the image data of faces in the memory. The specific photographing object may be the photographer's child, for example. That is, assumption is that the faces of photographing objects with which the photographer generally feels a high level of intimacy and which therefore the photographer considers important photographing objects, are stored in a memory in advance. Furthermore, when the motion of the face of a photographing object is detected, since camera shake correction has been carried out earlier, motion can be detected in a state where the influence of camera shake is reduced, so that the accuracy of motion detection can be improved. That is, it is possible to decide whether the motion of the image in imaging sensor 4 is caused by the motion of the photographing object or is influenced by the motion of the camera caused by camera shake by the photographer. Furthermore, in the motion detection process, motion detection section 100 detects the motion of the face of the object to be photographed, and outputs a motion vector.

In step 24, microcomputer 3 calculates the moving speed Vh of the face of a specific photographing object per unit time from the motion vector detected in motion detection section 100.

In step 7 the moving speed Vh is decided, and the process moves to step 8 or step 9.

In this way, when the moving speed Vh of the face of the specific photographing object is lower than the threshold A, photographing sensitivity is not changed and the camera shake correcting function is started. This reduces camera shake and allows an image of high quality to be taken. Furthermore, when the moving speed Vh of the face of the specific photographing object is equal to or higher than the threshold A, high photographing sensitivity is set. By this means, exposure time can be made shorter and a photograph can be taken at a high shutter speed, so that object shake can be prevented. Incidentally, in “sensitivity increasing mode,” the camera shake correcting mechanism may or may not be operated.

As described above, according to Embodiment 2, when the photographing object is moving fast, photographing sensitivity is changed to high sensitivity according to the motion of the face of the specific photographing object and a photograph is taken with a short exposure time and at a high shutter speed, and, consequently, as in Embodiment 1, the mode is not shifted to “sensitivity increasing mode” in the situation where the face of the photographing object does not move much, so as to prevent photographing sensitivity from being increased more than necessary. When the photographing object is moving slowly, this prevents image quality degradation caused when ISO sensitivity is increased. Furthermore, as in Embodiment 1, when the motion of the face of the photographing object is slow, the camera shake correcting function is started, so that if is possible to prevent camera shake and reduce image quality degradation.

Furthermore, according to the present embodiment, the mode is changed to “sensitivity increasing mode” based on the face of a specific photographing object among the faces of photographing objects, and, consequently, when the face of a photographing object considered as an important photographing target by the photographer does not move much, the mode is not shifted to “sensitivity increasing mode” even when the face of a photographing object other than the specific photographing object moves fast, thereby even more strictly preventing photographing sensitivity from being increased more than necessary. This is useful when a group photograph is taken, and detecting the motion of the face of a specific photographing object and determining photographing sensitivity eliminates the necessity for increasing photographing sensitivity more than necessary, even when, for example, photographing objects other than the photographer's child move, and can thereby prevent image quality degradation caused by increased photographing sensitivity.

The above described explanations are illustrations of preferred embodiments of the present invention and the present invention is by no means limited to these.

The present invention is applicable to any electronic apparatus which having imaging apparatus. For example, the present invention is applicable not only to digital cameras and video cameras but is also applicable to information processing apparatus such as cellular phones with a camera, portable information terminal such as personal digital assistants (PDA's), and personal computers with imaging apparatus.

Furthermore, the configuration of the imaging optical system and the camera shake correcting section of the above embodiments are not limited to the examples described herein. For example, the camera shake correcting section may drive the imaging sensor in two directions perpendicular to the optical axis with respect to the imaging optical system. Furthermore, for example, the camera shake correcting section may change the angle of the prism mounted in the front in the photographing object side of the lens barrel or may drive the whole of the lens barrel, and the configuration is not limited to these configurations as long as camera shake can be corrected.

Furthermore, it is also possible to adopt electronic camera shake correction schemes of correcting camera shake by changing positions for sampling image in the imaging sensor or taking a plurality of photographs of the same photographing object at short shutter speed and combining these photographs into one image. Obviously, the scheme is not limited to these or to the examples described herein.

Furthermore, although cases have been described with the above embodiments where the moving speed of the photographing object is calculated using a motion vector, the present invention is not limited to this and the moving speed of the photographing object may be detected using an external sensor separately.

Furthermore, although cases have been described with the above-described embodiments where exposure time to the imaging sensor is controlled by operating the shutter, the present invention is not limited to this, and exposure time to the imaging sensor may be controlled using an electronic shutter or the like.

Furthermore, although a case has been described above with the present embodiment where a plurality of photographs can be taken consecutively by operating the shutter operation section once, it is also possible to adopt a system whereby it is possible to take a picture only while the shutter operation section is operated (pressed).

Furthermore, although cases have been described above with the embodiments where AF areas are set by detecting a face, but a system may be employed as well whereby the AF area may be set by detecting specific colors.

Furthermore, although cases have been described above with the embodiments where the motion of the face of the photographing object is detected, this is by no means limiting, and further applications may be possible. For example, a system for starting taking a photograph when the photographing object or the face the photographing object moves, using that move as a trigger, may be possible. With this example, the system may prove more effective adopting continuous shooting and movie taking. Furthermore, a system for starting taking a photograph when the photographing object smiles, using the smile of the photographing object as a trigger.

Furthermore, although the digital camera according to the present embodiment has an imaging optical system, the present invention is not limited to this. As in the case of a single-lens reflex camera system, the present invention is also applicable to imaging apparatus where a lens barrel that holds an imaging optical system and a camera including an imaging sensor are used separately. For example, the present invention is applicable to the whole of a system where a lens barrel that holds an imaging optical system and a camera are provided separately and the photographer can use the lens barrel and the camera in combination.

In the case of the single-lens reflex camera system, the value of the aforementioned threshold at which object shake occurs may be made settable as follows. When, for example, a photograph is taken with a standard replacement lens having a focal length of 100 mm or less on a 35 mm basis mounted, the influence of camera shake is less. On the other hand, when a photograph is taken with a telephoto replacement lens exceeding 300 mm, the influence of camera shake is significant. Therefore, the threshold may be changed according to the focal length of the replacement lens used. In this case, the threshold may be increased when a standard replacement lens of 100 mm or less is used and the threshold may be decreased when a telephoto lens exceeding 300 mm is used. Furthermore, as for the focal length of the replacement lens, the camera may be made to read focal length information of the lens when the replacement lens is mounted in the camera so as to be able to automatically set a threshold. Alternatively, the photographer may set the threshold manually.

Furthermore, although with the present embodiment, the term “imaging apparatus” is used for ease of explanation, other terms such as “photographing apparatus,” “digital camera” and “imaging method” may be used as well.

Moreover, the components configuring the above-described digital camera, for example, the type of the imaging optical system, the drive section and the mounting method, and moreover the type of the detecting section or the like are not limited to the embodiments described herein.

Furthermore, the imaging apparatus explained above can also be implemented by a program for making the photographing control method for this imaging apparatus function. This program is stored in a computer-readable record media.

As described above, the present invention can provide an imaging apparatus capable of preventing photographing sensitivity from being increased more than necessary, reducing image quality degradation due to camera shake or object shake and easily photographing images in good image quality.

The imaging apparatus according to the present invention is suitable for use in a digital still cameras and digital video cameras where image in good image quality is required, cellular phones having a camera section and PDA'S.

What is claimed is:

1. An imaging apparatus comprising:
an imaging optical system that forms an optical image of a photographing object;
an imaging sensor that receives the formed optical image, converts the optical image to an electrical image signal and outputs the image signal;
a face detection section that detects a face of the photographing object based on the image signal;
an object speed decision section that measures motion of the optical image of the face of the photographing object in a predetermined time before a photograph is taken, and calculates an object speed of the photographing object; and
a control section that takes, when the calculated object speed is equal to or higher than a threshold, a photograph at a higher amplification factor of the image signal and in a shorter exposure time.

2. The imaging apparatus according to claim 1, further comprising a face selecting section that selects, when the face detection section detects a plurality of faces, a specific face from the plurality of faces.

3. The imaging apparatus according to claim 1, further comprising a camera shake correcting section that corrects shake of the optical image caused by motion of an imaging apparatus body,
wherein, when the object speed is lower than the threshold, the control section causes the camera shake correcting section to carry out camera shake correction and takes a photograph.

4. The imaging apparatus according to claim 3, wherein, when the calculated object speed is equal to or higher than the threshold, the control section takes a plurality of photographs applying different exposure times.

5. The imaging apparatus according to claim 1, wherein, when the calculated object speed is equal to or higher than the threshold, the control section takes a plurality of photographs applying different exposure times or different amplification factors.

6. The imaging apparatus according to claim 3, wherein the control section takes a plurality of photographs while executing at least one of control for shortening the exposure time sequentially for every photograph and control for increasing the amplification factor sequentially for every photograph.

7. The imaging apparatus according to claim 1, wherein the control section predicts an object speed upon photographing based on an amount of change in the object speed in the predetermined time and controls the exposure time or the amplification factor according to the predicted object speed.

8. The imaging apparatus according to claim 1, further comprising a threshold input section that sets the threshold of the control section from outside.

9. An imaging apparatus body used in combination with a lens barrel mounted with a camera shake correcting section that corrects shake of an optical image caused by motion of the imaging apparatus body, the imaging apparatus body comprising:
an imaging sensor that receives a formed optical image, converts the optical image to an electrical image signal and outputs the image signal;
a face detection section that detects a face of a photographing object based on the image signal;
an object speed decision section that measures motion of the optical image of the face of the photographing object in a predetermined time before a photograph is taken, and calculates an object speed of the photographing object; and
a control section that takes, when the calculated object speed is equal to or higher than a threshold, a photograph at a higher amplification factor of the image signal and in a shorter exposure time.

10. The imaging apparatus according to claim 9, further comprising a face selecting section that selects, when the face detection section detects a plurality of faces, a specific face from the plurality of faces.

11. A lens barrel used in combination with an imaging apparatus body, the imaging apparatus body comprising:
an imaging optical system that forms an optical image of a photographing object;
an imaging sensor that receives the formed optical image, converts the optical image to an electrical image signal and outputs the image signal;
a face detection section that detects a face of the photographing object based on the image signal;
an object speed decision section that measures motion of the optical image of the face of the photographing object in a predetermined time before a photograph is taken, and calculates an object speed of the photographing object; and
a control section that takes, when the calculated object speed is equal to or higher than a threshold, a photograph at a higher amplification factor of the image signal and in a shorter exposure time,
the lens barrel comprising:
a camera shake correcting section that corrects shake of the optical image caused by motion of the imaging apparatus body; and
an interface between the camera shake correcting section and the control section of the imaging apparatus body.
